(19) United States
(12) Patent Application Publication
(10) Pub. No.: US 2007/0285475 A1
(43) Pub. Date: Dec. 13, 2007

(54) Inkjet cartridge refilling machine with improved refill process

(76) Inventors: E. Mariano Freire, Kennett Square, PA (US); Zlatko Vujic, Nashville, TN (US); Sergio Tonini, Franklin, TN (US); Terry Rowlison, Murfreesboro, TN (US); Richard Hoehn, Thompson Station, TN (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/732,153

(22) Filed: Apr. 2, 2007

Related U.S. Application Data
(60) Provisional application No. 60/794,618, filed on Apr. 24, 2006.

(51) Int. Cl. B41J 2/175

(52) U.S. Cl. 347/85

(57) ABSTRACT

A method and apparatus is provided for refilling an ink reservoir associated with an ink jet printer cartridge containing foam material in the ink chamber of the cartridge. The method employs a two cycle process, the first filling cycle occurring under vacuum and the subsequent filling cycle operating under substantially atmospheric conditions. The method improves the page yield of the refilled cartridge, as compared to cartridges refilled with the same ink under vacuum alone.

### CROSS-REFERENCE TO RELATED APPLICATION

This application claims the benefit of U.S. Provisional Application Ser. No. 60/794,618, filed on Apr. 24, 2006 which is hereby incorporated by reference in its entirety.

### FIELD OF THE INVENTION

The present invention relates to ink jet cartridges. More specifically, the present invention relates to an improved method and device used to refill ink jet cartridges.

### BACKGROUND OF THE INVENTION

Ink jet printing is a non-impact printing process in which droplets of ink are deposited on print media, such as paper, to form the desired image. The droplets are ejected from a printhead in response to electrical signals generated by a microprocessor.

Many of these ink jet printers contain ink cartridges. The ink cartridges can simply be ink tanks containing a supply of ink or can be integrated printhead cartridges which incorporate both an ink tank and printhead. To prevent ink from leaking out of the cartridge during handling and non-use, the ink is usually stored under negative pressure. This is sometimes achieved, without limitation, by having the ink chamber house either a porous material, such as foam or sponge, or a collapsible bladder attached to a system of plates and springs to contain the ink supply.

An ink cartridge may have only one ink chamber and contain only a single color ink, such as black ink (K) for a monochrome printer. Typical color printers use one cartridge that holds only black ink (K) and a second cartridge that has three separate ink chambers that contain three different colors of ink that can be blended to produce any color in the spectrum. The three colors most often used are cyan (C), magenta (M), and yellow (Y). Individual colors may also be provided via individual cartridges.

As the printing process consumes the ink in a printer cartridge and the cartridge is depleted (including the case where only one of the inks from a tri-color cartridge is depleted), the cartridge must be replaced or refilled.

Nowadays, most users simply discard the old cartridge and buy an entirely new printer cartridge when the ink cartridge in use is emptied, which is a very expensive proposition that is difficult to bear. However, particularly with regard to integrated head ink cartridges, the current printhead technology has advanced to the point where the useful life and reliability of the structural components of the printhead, such as the resistive heater elements that enable vaporization and ejection of ink in thermal ink jet cartridges, extend far beyond the usage life of the self-contained ink supply. It is seen that discarding an ink cartridge simply because its ink charge has been expended is wasteful and environmentally unfriendly.

Technologies have recently developed that have enabled the construction of refill stations that can be operated as kiosks in retail outlets where customers can bring their empty ink cartridges for refilling. Such refilling stations are disclosed in, for example, U.S. Pat. Application Pub. No. 2006/0017789, U.S. Pat. Application Pub. No. 2005/003477, U.S. Pat. No. 6,729,360, and commonly-owned U.S. patent application Ser. No. 11/236.989 (filed Sep. 28, 2005), the disclosure of which is incorporated herein by reference for all purposes as if fully set forth). These stations allow the consumer more affordable options for filling the cartridge, are environmentally favorable since old cartridges can be recycled, reduce the risk of damage to the printing nozzles and electronic circuitry during refilling, ensure that the cartridge is filled with the proper ink type and quantity, and also perform a cartridge diagnostic to ensure the cartridge is operating properly and does not pose a hazard to the printing device.

The most common approach to refill foam-based cartridges is through either an already existing vent hole or a new hole formed in the cartridge by means of an ink-filled syringe or other similar tubular device connected to a refill ink supply. Such method therefore typically involves the use of hollow needles that are inserted in the cartridge to deliver the ink.

Methods that involve needles are particularly useful for refilling these cartridges because the needles can conveniently place the ink inside the foam. Once the ink is placed in the foam so that the foam is at least partially saturated, the capillary force delivered by the pores in the material provides the negative pressure to the ink line that prevents the ink from leaking out of the nozzles.

While use of needles significantly simplifies the refill process, placing the ink in the foam does not warrant that the process is clean and free of spills. Nor does it ensure that the cartridge will be adequately filled and ready to be used after the refill process is finished.

For instance, the needle filling process typically will not deliver ink to nozzles, and therefore the cartridge is not primed and ready to print. To solve this problem, refill machines such as disclosed in previously incorporated commonly-owned U.S. patent application Ser. No. 11/236,989 (filed Sep. 28, 2005) utilize a procedure whereby the nozzles are initially sealed and then the refill process is conducted in vacuum. Refilling under vacuum prevents air from being trapped in the ink delivery ducts (located inside the cartridge to carry ink from the foam to the nozzles) and leaves the nozzles primed so the cartridge is ready to print. Another common way of addressing the priming problem is to refill under atmospheric conditions and then apply vacuum to the front face of the printhead to prime the nozzles.

However when using either process, not enough ink is able to be dispensed because the flow of ink into the foam is not uniform and typically leaves voids. Oftentimes, overflowing out of the fill holes is also a problem. The net result is that the page yield of the refilled cartridge is significantly lower than what a new OEM printer cartridge can deliver.

Thus, there is still a need for methods and devices that can be used to refill empty ink jet cartridges especially in a retail environment, that are free from ink spills or overflows, that maximize the amount of ink dispensed into the cartridge so as to improve the page yield, and that leaves the cartridge ready to function properly in a printer.

### SUMMARY OF THE INVENTION

The present invention solves the forgoing refilling problems by conducting an ink jet cartridge refill process in two steps and by dispensing the ink at a flow rate low enough for the ink to spread evenly throughout the foam. The invention comprises, in the first step dispensing a portion of the total amount of ink under vacuum. This ensures that the cartridge is properly primed. After the first step, the vacuum is released so that all the air bubbles trapped in the foam shrink in volume. After the bubbles are shrunk, the remaining portion of ink is dispensed. As stated above, the whole process is done at a slow enough ink flow rate to ensure uniform spreading of the ink into the foam.

The present invention also provides a one-step refill process that employs a slow enough ink flow rate to ensure uniform spreading of the ink into the foam, regardless of whether the refill process is conducted under vacuum.

### BRIEF DESCRIPTION OF THE DRAWINGS

The accompanying drawings illustrate preferred embodiments of the present invention and are a part of the specification. Together with the following description, the drawings demonstrate and explain the principles of the present invention. The illustrated embodiments are examples of the present invention and do not limit the scope of the invention. In the drawings:

FIG. 1 is a perspective view of an ink cartridge refilling station that employs the refill method of the present invention.

FIG. 2 shows a vacuum filling chamber and fill fixture with needles used to fill foam-based cartridges.

FIG. 3 shows a centrifuge used to remove residual ink in the cartridge before refilling.

FIG. 4 shows a drill used to form fill holes in an emptied cartridge.

FIG. 5 is a block diagram of the two-step refilling process according to the teachings of the present invention.

FIG. 6A and 6B when taken together show the results of a refill experiment run on HP (Hewlett-Packard) 57 ink jet printer cartridges. The data shown in the table indicates that a gain in total net ink added of 21% was achieved with the two-step process according to an embodiment of the present invention.

FIG. 7 shows the results of a refill experiment where the HP 57 cartridges were refilled in atmospheric pressure at various speeds. The data shown in the graph indicates that substantially larger ink refill amounts (15% more ink) are possible with slow pumping speeds (below 0.26 ml/s) according to an embodiment of the present invention.

### DETAILED DESCRIPTION OF THE PREFERRED EMBODIMENTS

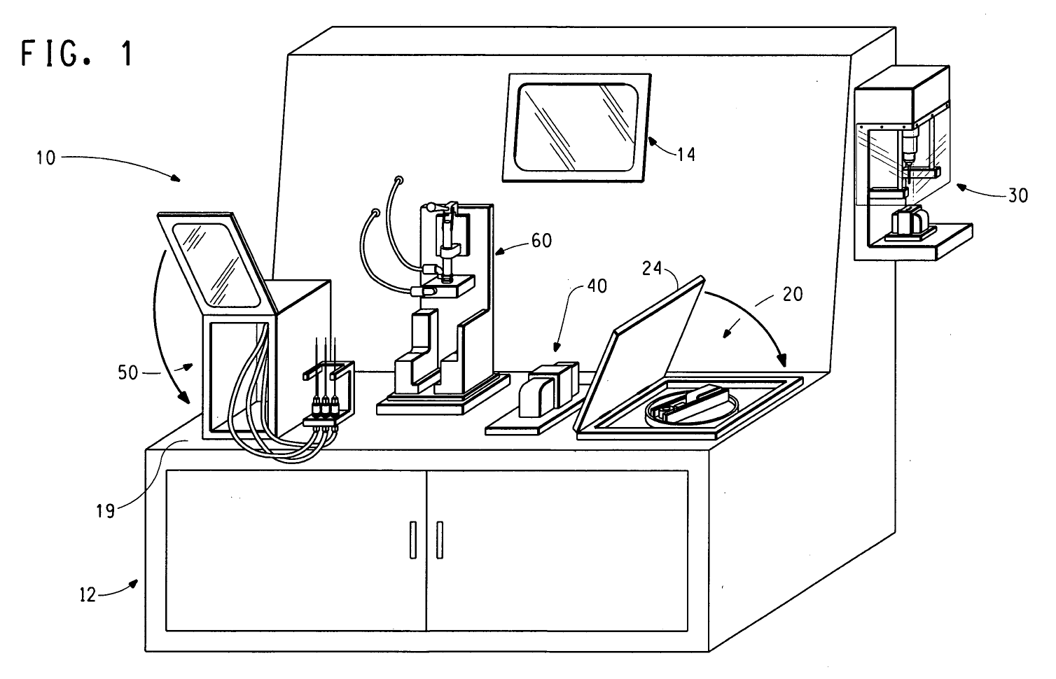

Referring to the drawings, in which like numerals indicate like elements throughout, there is shown in FIG. 1 a drawing of an ink cartridge refilling station 10 in which the improved refilling method according to the invention can be used.

The ink refilling station 10 as shown in FIG. 1 provides a system that allows a user, preferably a trained retail associate, to add ink to a printer cartridge. The refilling station 10 is preferably operated as a kiosk in a location that is publicly available, such as in a retail store for office supplies. The cartridge refilling station is suitable for refilling and testing a variety of used ink jet cartridges (such as those by different printer manufacturers) quickly, easily and affordably.

The cartridge refilling machine 10 comprises a cabinet 12 that houses a computer (not depicted), a touch screen display 14 for the computer, a centrifuge station 20 for removing residual ink from the cartridge, a drill station 30 for drilling new ink fill holes in the cartridge, a cleaning station 40 for cleaning the cartridge before refilling, an ink supply reservoir (not depicted) that contains inks for various different cartridges, and a filling station in communication with the ink supply reservoir for delivering ink to the empty cartridge.

In general, the computer controls the operation of the refilling machine via software loaded onto the computer, and in conjunction with input received from the operator via the touch screen display; the cleaning station is for cleaning the printhead of the cartridge; the centrifuge station is for removing at least a substantial portion of the residual ink from the ink tank of the cartridge; the drill station is for drilling one or more access holes to the ink tank of the cartridge (where required); and the filling station is for filling replacement ink into the ink tank of the cartridge.

In the preferred embodiment as depicted in FIG. 1, the machine filling station includes both a vacuum filling device 50 and a pressure filling device 60, as discussed in further detail below. The presence of both devices 50 and 60 provides the refilling machine 10 with the capability to process the two most common types of cartridges—those with a foam or sponge in the ink tank (using vacuum filling device 50) to which this invention pertains, and those with a bladder in the ink tank (using pressure filling device 60).

The machine 10 further includes a circuit test station (not depicted) for testing the cartridge electronics prior and/or subsequent to refilling, and a print test station (not depicted) for testing the print functionality of the cartridge subsequent to refilling. The circuit and print test stations may be separate from (not an integrated part of) machine 10, but are preferably part of an integrated assembly and are housed in cabinet 12.

Cabinet 12 provides a suitable housing for the touch screen display 14, and further houses the centrifuge station 20, the drill station 30, the cleaning station 40 and the filling station, as well as all associated valves, pumps, tubing, and computer and electronic process control systems in connection therewith (not depicted but as described in further detail below). The cabinet 12 may also contain any other items that the operator desires to store, or that is convenient for the operation of machine 10, such as counterweights for use with centrifuge station 20, a compressor for use with cleaning station 40 and the filling station, and containers of replacement ink.

The ink jet cartridge refilling machine as shown is capable of processing, refilling and testing a used ink jet ink cartridge of various types including the type containing (a) a stand alone ink tank with residual ink and (b) an integrated printhead such as an integrated thermal printhead to which this invention pertains. Depending on the type of cartridge being refilled, as noted above, different fill fixtures may be used.

The present invention will now be discussed generally in the context of refilling foam-based cartridges, particularly integrated head thermal ink jet cartridges. One skilled in the art would understand that the process of the present invention also is useful for refilling any foam-based cartridge, including integrated head, individual tanks, piezo, and thermal cartridges.

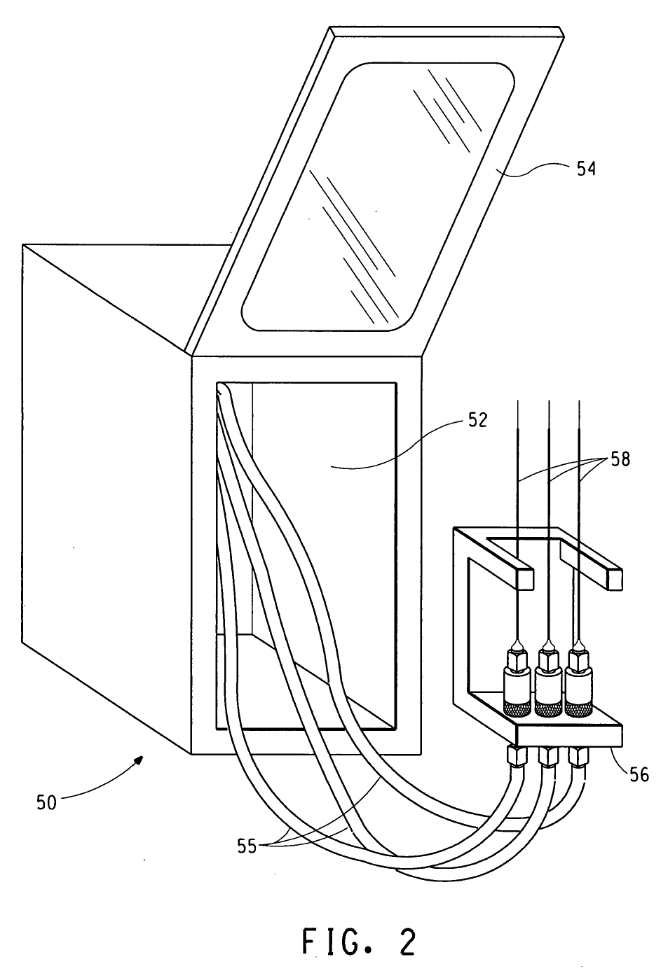

With respect to the cartridges that contain a sponge or foam in the ink reservoir for delivery of ink to the printhead, a fill fixture 56, as indicated above, with needles 58 is typically employed. As indicated above, the vacuum filling device 50 is designed for use with cartridges containing a sponge or other porous material in the ink tank and is depicted in more detail in FIG. 2.

Vacuum filling device 50 contains a chamber 52 including a hinged cover 54 which, when closed, allows the operator to utilize chamber 52 for negative air pressure cartridge filling. During filling, ink is metered from storage containers (not depicted) housed in cabinet 12 to the cartridge via flexible fill lines 55 and a fill fixture. A variety of fill fixtures can be utilized, such as fixture 56 in FIG. 2, each including hollow needles 58 of specific diameter, length and position designed allow the delivery of ink to specific cartridge types. For example, a simple black ink cartridge like the HP27 (Hewlett Packard Company) may need one needle, while a tri-color cartridge will need several needles, at least one for each color to be added to the cartridge.

The individual fill fixtures 56 are designed such that, when the needles 58 are inserted into the correspondingly matched cartridge holes (not depicted), the filling occurs in the ink tank of the cartridge as close to the integrated printhead as possible and also at a position that allows the ink to adequately impregnate or saturate the foam material. The negative air pressure (vacuum) in chamber 52 potentially helps draw the replacement ink to the integrated printhead, thereby removing any air or other potential blockage between the ink supply and the integrated printhead.

Before the filling process is initiated, it is generally preferred to remove substantially all of the residual ink in the cartridge and also create the necessary access hole(s) in the cartridge body and clean the printheads.

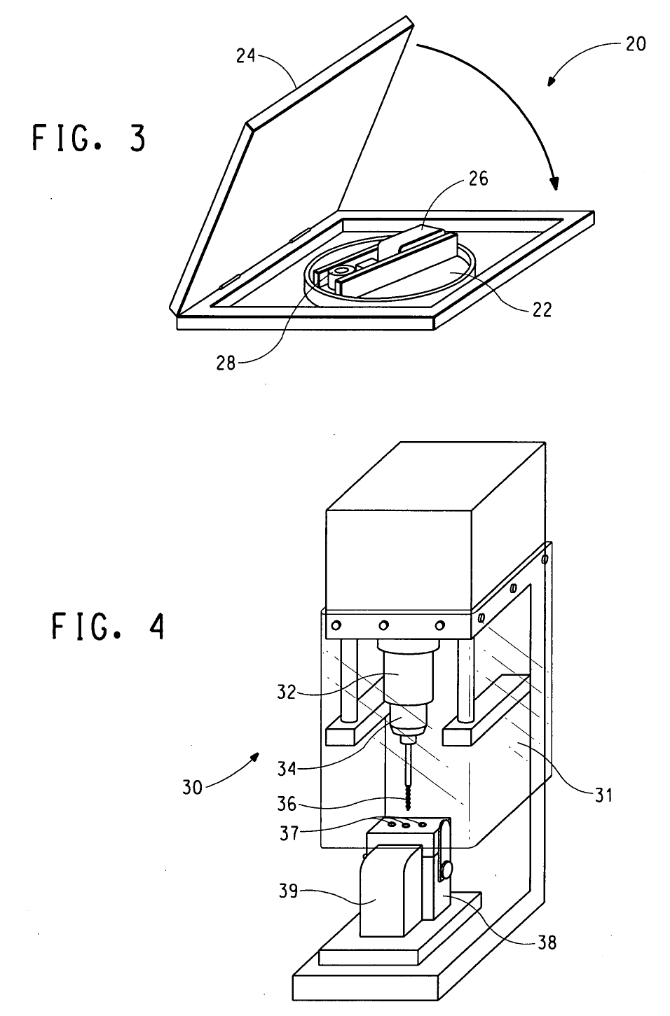

A preferred step before the cartridge is refilled is thus to remove at least a portion of residual ink in the cartridge utilizing the centrifuge station 20 or other suitable device, as shown in FIGS. 1 and 3. Preferably, as much as reasonably possible of the old ink in the cartridge is extracted.

In one preferred embodiment, as discussed below, the operation of machine 10 is designed to insert a predetermined amount of ink into each cartridge so, in such embodiment, it will be important that substantially all of the unused ink be removed from the cartridge. If some of the “old” ink remains in the cartridge, then the new ink could fill past the desired stop point and possibly overflow, potentially causing damage to the cartridge and/or the machine.

The centrifuge 22 contained in centrifuge station 20 is preferably housed below the work surface 19 of cabinet 12, and is universal; that is, it can be used with almost any type of cartridge. A variety of counterweights are also provided (that can be housed in cabinet 12) that must be properly selected and inserted into the centrifuge to ensure proper operation.

The centrifuge station 20 also preferably comprises a hinged door 24, which opens to allow the operator to insert a cartridge and any required counterweights into the centrifuge.

In a preferred embodiment, the touch screen display 14 then instructs the operator to insert the cartridge into the centrifuge 22 of the centrifuge station 20, and it tells the operator which counterweight to use to balance the centrifuge. Preferably, the counterweights are color-coded to minimize operator error. The particular counterweight used is determined by the cartridge type. As depicted in FIG. 3, the operator opens the centrifuge door 24, places the cartridge 26 in its proper location and adds the counterweight 28. The operator then closes the centrifuge door 24.

When the instructions on the touch screen display 14 instruct the operator to start the centrifuge 20, the operator presses a “start” button on the touch screen display 14. The software should contain instructions to prevent centrifuge 22 from starting while the hinged door 24 is open and, after centrifuge 22 starts, should automatically cause hinged door 24 to lock in the down position for safety reasons. After the centrifuge cycle is completed and centrifuge 22 stops, the hinged door 24 should automatically unlock when it is safe for the operator to reach inside and remove cartridge 26 and counterweight 28. Counterweight 28 can then be stored in its appropriate place in cabinet 12, and the operator should close centrifuge door 24 once the centrifuge cycle is complete.

In a preferred embodiment, once the centrifuge cycle is completed, the operator is instructed in one of two ways depending on the cartridge type.

If the cartridge is of a type in which the ink tank contains a foam or sponge, namely the type of cartridge to which this invention pertains, the operator will be instructed to move the cartridge from the centrifuge station 20 to the drill station 30 to drill one or more access holes in the top of the cartridge, both of which allow access to the ink tank portion of the cartridge without removing the top of the cartridge.

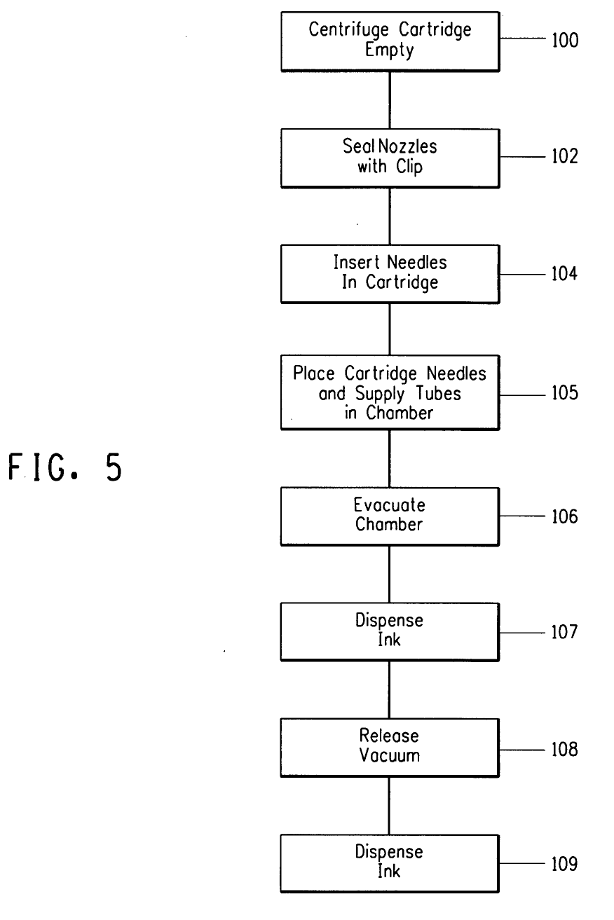

If drilling is used, the drill station 30 is preferably comprised of a universal platform (drill assembly 32) as shown in FIG. 4. The drill station 30 utilizes one of several specific cartridge holding fixtures designed to safely hold the cartridge while the operator drills holes, a precision drill 34 for housing at least one drill bit 36 (and as many as three drill bits) so that the desired number of holes can be drilled into the top of the cartridge. One such cartridge holding fixture 38 is shown in FIG. 4, which is designed for drilling three holes in cartridge 39. The exact number of holes to be drilled, the corresponding number of drill bits necessary, and the exact location of the holes to be drilled, is determined by the type of cartridge to be filled, and will be indicated on the touch screen display 14.

Further, the drill station 30 may comprise a lever (not depicted) for raising and lowering the drill assembly 32 relative to the cartridge 39, and for limiting the depth of each drilled hole to a pre-determined amount. Drill station 30 should also include a transparent shield 31 around the cartridge and drilling area so as to protect the operator from debris from the drilling process. The drill 34 in drill assembly 32 is typically an electric drill that is electrically connected to the machine so that the operator can activate a switch (not depicted) on the cabinet 12 surface and start the drilling process. Having a separate operating switch on cabinet 12 for drill assembly 32, as opposed to on/off control via the computer and software, is preferred for safety reasons.

At drill station 30, the operator places the cartridge 39 into the appropriate cartridge holding fixture 38, then into drill assembly 32 to drill the appropriate number of access holes into the top of the cartridge. As depicted in FIG. 1, the operator then drills three holes through the drill positioning holes in cartridge holding fixture 38.

In one preferred embodiment, when the drill step has been completed, the operator is instructed by the touch screen to move on to cleaning station 40, as shown in FIG. 1. The cartridge 36, however, can remain in holding fixture 38 for the cleaning step, as discussed below.

Cleaning station 40 is utilized to clean the printhead area of the cartridge. The operator is directed to load the cartridge into a holding fixture (if the cartridge was removed from the holding fixture in the drilling step), which is typically the same holding fixture as used in the operation of the drill station, then directed to position the holding fixture into the cleaning station oriented so that multiple nozzles (not depicted) positioned about the printhead area satisfactorily clean the printhead area of the cartridge. The holding fixture is designed to orient the cartridge printhead at the optimum location for maximum effectiveness during cleaning. It should be understood that any number of nozzles and positions could be utilized so long as the printhead area of the cartridge is adequately cleaned.

In a more preferred embodiment, the cleaning station 30 contains two built-in nozzles (not depicted) that are housed below the work surface 19 of the cabinet 12. One nozzle is pointed at the bottom of the cartridge at about 45 degrees from horizontal, and the second nozzle is pointed directly at the bottom of the cartridge and sprays in the same plane as the bottom of the nozzle. Both nozzles use atomized water molecules to gently spray away ink residue on and inside the cartridge printhead. Both of the nozzles are electrically connected to each other and to a switch (not depicted) that is activated by the computer control when so instructed by the operator by input via touch screen display 14.

In an alternative embodiment, one could position the cartridge in a universal location relative to a predetermined number of nozzles. The nozzles would, as described above, use atomized water to clean the print head area.

Once the cleaning process is indicated to be complete, touch screen display 14 provides instructions to the operator as to the appropriate fill device and instructions for filling the cartridge.

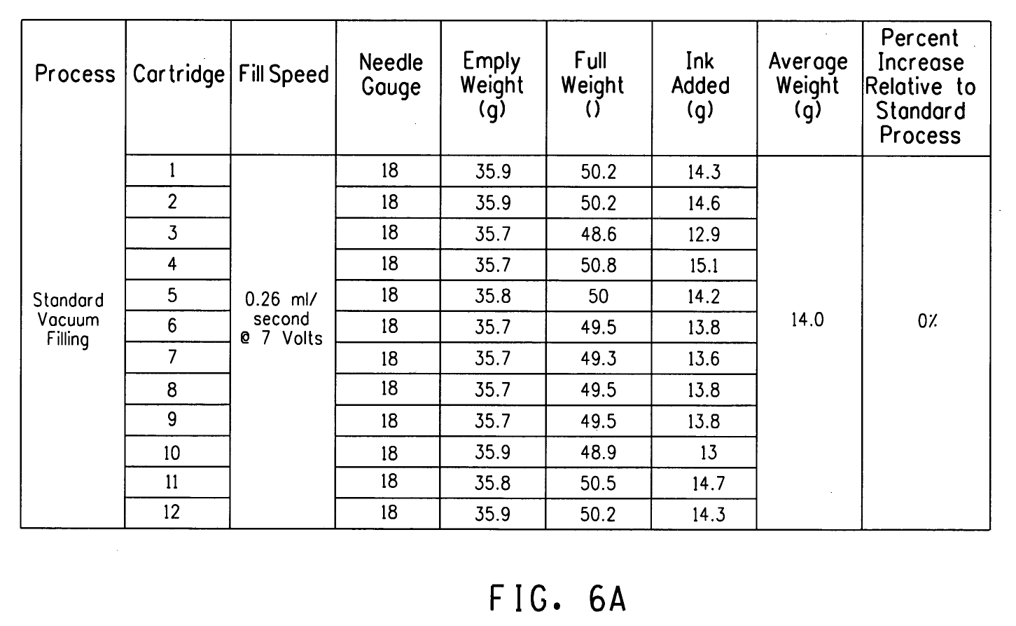

In accordance with the present invention, as shown in FIG. 5, after substantially all residual ink is removed from the foam-based cartridge in step 100 and optionally the printheads have been cleaned, a decision is made to initiate a refill operation in the refill station 10 using the vacuum fill fixture 56.

Touch screen display 14 identifies to the operator the suitable fill fixture to use based on the specific cartridge, then instructs the operator to connect the fill fixture to the appropriate fill lines 55 in vacuum chamber 52, and insert the filling fixture needles 58 into a waste drain (not depicted) which can conveniently be located between vacuum filling device 50 and pressure filing device 60. The operator should ensure at this point that everything is properly connected.

Touch screen display 14 then informs the operator that, when the filling process is started, the machine will prime the fill fixture by purging ink (not depicted) through the fill lines and filling fixture and into the waste drain. While the machine is purging ink, the operator is instructed to wait. The purging removes previously used ink, water and air from the filling fixture and fills lines to help ensure that only replacement ink is fed into the cartridge ink tank.

When the purging is complete, the operator is instructed in step 102 to seal the nozzles with a damping device or holding dip (see below). Next, in step 104, the operator is instructed to insert the needles into the access holes previously drilled into the cartridge.

The operator is then instructed to place the cartridge and supply tubes 55 into the chamber 52, with the clamping device and filling fixture on the cartridge, in step 105. Next, the operator is instructed to close hinged cover 54 of enclosure 52 and ensure that the cartridge is properly positioned. When everything is in order, the filling may begin. When the operator is ready to proceed, the operator presses a start button on the touch screen display 14.

Once the filling has started, touch screen display 14 shows the stages of filling as they are completed and the time remaining to fill the cartridge. When filling is complete, the operator is instructed to open hinged cover 54 and remove the cartridge from enclosure 52. Then, the operator is instructed to remove the cartridge from the filling fixture and place the filling fixture needles into the waste drain, after which they are purged with water, while the operator continues with hand cleaning and print testing the cartridge.

To address the spill issue, prior to starting the refill process, the nozzles in the printhead are typically sealed before the refill process is started. This is usually done by means of the holding clamp or sealing mechanism (not depicted) especially designed to press a compliant impermeable material against the nozzle face of the cartridge. Accordingly, in a preferred embodiment, as shown in FIG. 5, the first step 102 in the refill process preferably comprises sealing the printing nozzles of the ink jet printer cartridge to substantially prevent leakage of air or ink from the cartridge through the nozzles.

The clamping device (not depicted), which is made of a compliant material designed to seal the nozzles during the refill process and prevent spills through the printing nozzles of the printhead during refill operations, is inserted over the printhead nozzles on the cartridge body. Preferably under mechanical clamping pressure, a leak-proof seal with the nozzles in the printhead is created. In a preferred embodiment, the clamping device is attached to the cartridge prior to insertion of the needles. The clamping mechanism is preferably an inexpensive molded plastic component that is configured to snap lock onto the cartridge and at least seal the printhead nozzles.

The next step 104 of the process comprises inserting the needles 58 of fill fixture 56 into the existing vent hole or previously drilled access holes in the cartridge until the needles can no longer travel, to establish fluid contact with the ink chamber in the cartridge body and ensure that the filling occurs as close to the printhead as possible. As shown in FIG. 2, this step is preferably accomplished with the fill fixture arranged so that the needles are pointing down, and then inserting the needles 58 into the access holes in the cartridge body, when the fill fixture is manually moved downward to establish fluid contact with the ink chamber in the cartridge body.

When drilled access holes 37 are used, which is the preferred embodiment, the access holes in cartridge body are also normally positioned opposite the printhead nozzles to ensure that the end of the needles after insertion is near the printhead nozzles.

Of course, the first two steps described above, can be done in any order before refill ink is supplied to the cartridge, as described in the next steps.

In order to begin the two-cycle refill process in accordance with the present invention, the fill fixture 56 and cartridge body with sealed nozzles are then placed in the vacuum chamber 52, a vacuum is drawn in the chamber in step 106, and as the vacuum is drawn, air is removed from the cartridge body past the needles or other vent holes present in the cartridge, and then in the next step 107, ink is forced to flow into the ink chamber in the cartridge body. The ink is metered until the desired volume of ink is reached in the ink chamber of the cartridge body. In the embodiment shown, the vacuum in the chamber is created by passing compressed air through a Venturi tube.

As the vacuum pressure is applied, the refill ink is dispensed from the refill ink supply reservoir (not depicted) under vacuum conditions and due to the vacuum conditions is forced to flow in the chamber to fill the chamber. A vacuum of equal to or larger than 300 mm of Hg (as defined as the difference between atmospheric pressure and the pressure in the vacuum chamber) has been found to produce satisfactory results. The refill operation under vacuum continues until the ink reservoir in the cartridge is filled to the desired ink level.

During the first fill step (or vacuum filing cycle), it is preferred to only use a fraction of the total amount of ink intended to be used to fill the cartridge. Typically, the amount of ink delivered to the cartridge in the first filling step 107, conducted under vacuum conditions is between 30% and 70% of the total amount intended to be used to refill the cartridge.

The next step 108 of the two-step fill cycle comprises releasing the vacuum and dispensing the remaining amount of ink intended to be used to fill the cartridge under substantially atmospheric conditions.

It has been found that during the first filling cycle 107 which is conducted under vacuum conditions, the ink is preferably dispensed at a flow rate no greater than 0.5 ml per second, preferably no greater than 0.25 ml per second, and typically in the range of about 0.2-0.25 ml per second. This rate is preferably continued through the entire refilling process.

It should be understood that when filling cartridges with foam, care must be taken in the way the ink is dispensed. The flow of the ink inside the foam is by no means uniform and, it can leave relatively large areas without ink. Furthermore, this can cause the ink to overflow through the access holes where the needles are inserted, even when the amount of ink being dispensed is well within the amount capable for the foam to absorb.

When ink is pumped too fast into the foam from the point source of the needle tip, the ink does not spread evenly and leave voids. Air can also be outgased by the ink in the low pressure environment, further exacerbating the problem. These two phenomena can result in a cartridge that has significant regions depleted of ink after the refill process. Such a cartridge would run out of ink well before the expected number of pages and would cause significant customer dissatisfaction. The refill process of the present invention is designed to overcome the forgoing problems.

It is also preferred that during the first filing cycle after the desired fraction of ink is dispensed, the vacuum is released over a period of 9 to 40 seconds.

The remainder of the refill process, as shown in step 109 in FIG. 5, is then conducted under atmospheric conditions, until the remaining portion of the intended ink charge is dispensed.

After the filling process is complete, it is also desired that the printhead and printing nozzles thereon have to be fully primed so that the cartridge is ready to print. In an empty cartridge the ink delivery system of ducts inside the cartridge that carries the ink from the foam to the nozzles is typically full of air. If ink were dispensed into the foam with the nozzles sealed under atmospheric pressure, the air would be trapped in those ducts and the cartridge may not be primed. The result is a cartridge with its ink reservoir full of ink but incapable of producing drops.

In the present invention these problems are overcome by filling under vacuum so that no air is trapped and the nozzles are fully primed after the refill process is concluded. By filing the cartridge in vacuum under specified conditions and with the nozzles sealed and releasing the vacuum after a significant portion of the ink has been loaded, the process of the present invention eliminate ink overflow and also leaks through the nozzles and substantially result in a ready to print fully primed cartridge.

When filling is complete, the operator is instructed to lift chamber door 54 and remove the cartridge from the chamber 52. The operator is also instructed to remove the needles from the cartridge along with the nozzle clamping mechanism, so that a print test of the cartridge can be conducted, the purpose of which is verify that the refill procedure was successful. While the operator continues with hand cleaning and print testing the cartridge, the fill lines 55 and needles 58 are purged with water.

For testing the cartridge, the cartridge is typically placed in a device that is in electrical contact with the electronics of the cartridge, and electrical signals are applied that cause the cartridge to print predetermined lines and/or shapes to confirm functionality of the individual nozzles on the printhead. Such devices are generally commercially available. It should be noted that a successful refilling does not require 100% functionality setting) of all nozzles; rather, it only requires a print quality of a predetermined level considered suitable for the customer.

To complete the refill process, assuming a satisfactory print test, the operator is instructed to appropriately label the refilled cartridge, clean the work surface 19 and reset the touch screen display 14 so that it is ready for the next cartridge. The refilled cartridge can at this point be returned to the customer. Preferably, the cartridge is then clamped with the nozzle clamping device and given back to the customer who restores the cartridge to its normal operating location on printer.

In the event that the cartridge does not pass the print test, the operator will be instructed to so advise the customer, and preferably dispose of the unsuitable cartridge.

Advantageously, the refill machine 10 and process of the present invention can complete the fill cycle in as little as about 8 minutes, so that the customer can conveniently wait in the retail store during the processing.

The following examples illustrate the invention without, however, being limited thereto.

### EXAMPLE 1

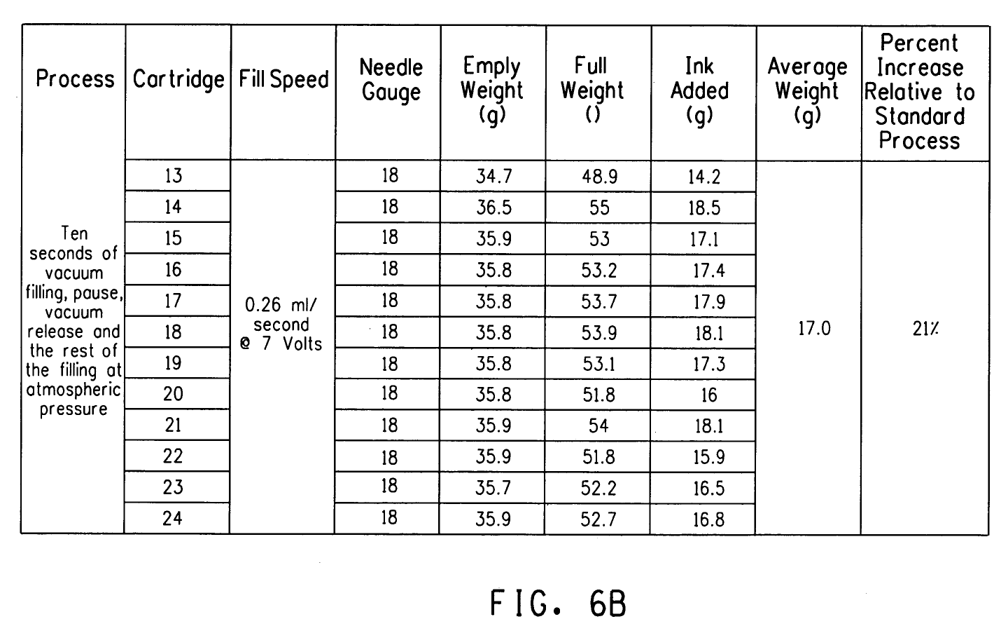

FIG. 6 shows the results of a refill experiment run on HP (Hewlett-Packard) 57 integrated head tri-color cartridge. The cartridges were emptied by a centrifuge process and then refilled. Ink was pumped into the cartridges until they overflowed. Weights of the cartridges before and after refill were taken. Two processes were used. In the first process the ink was pumped in one cycle, in vacuum. In the second process, the ink was pumped in two steps: vacuum filling was used during the first 10 seconds, then the vacuum was released and the rest of the filling was completed at atmospheric pressure. The data shown in the table indicates that a gain in total net ink added of 21% was achieved with the two-step process.

### EXAMPLE 2

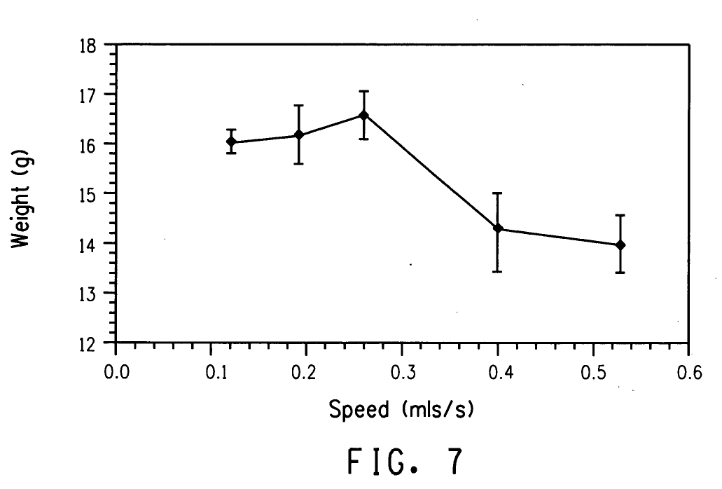

FIG. 7. shows the results of a refill experiment where the HP 57 (black ink) integrated head tri-color cartridge were refilled in atmospheric pressure at various speeds. The cartridges were centrifuged and then filled until they overflowed. Their weights were recorded before and after refill. The figure shows that substantially larger ink refill amounts are possible with slow pumping speeds. On average, at pumping speeds below 0.26 ml/s, it was possible to dispense 15% more ink to the HP 57 cartridges than at speeds higher than 0.26 ml/s, using the same ink, as compared to a one-step vacuum process using the same ink.

The results indicate that the present invention improves page yield of refilled cartridges, as compared to cartridges refilled with the same ink under vacuum alone. This process therefore allows refilled cartridges to print close to or essentially the same many pages as a new OEM printer cartridge.

As explained earlier the purpose of the foam in an ink jet cartridge is to deliver a certain amount of negative pressure to prevent weeping of the cartridge during operation. While different foam materials are sometimes used by different ink jet manufacturers in their cartridges, they all need to deliver the same performance. We have found that the results shown in these examples are typical of any foam-based ink jet cartridge.

The invention is applicable to refilling any type of foam-based ink jet cartridge configurations where needles are used. It will be appreciated by one skilled in the art that changes made from the embodiments heretofore described would not result in a departure from the inventive concept. It is therefore understood that this invention is not limited to the particular embodiments disclosed, but is intended to cover modifications that are within the spirit and scope of the invention as defined by the appended claims.

1. A process to refill ink jet cartridges, said process comprising:
a. sealing the nozzles of the cartridge to substantially prevent leakage of air or ink from the cartridge through the nozzles
b. inserting needles into the ink reservoir of the cartridge through existent vent holes and/or other previously made access orifices,
c. placing the cartridge with sealed nozzles and inserted needles into a chamber,
d. creating a vacuum inside said chamber,
e. dispensing in a first fill step, under the created vacuum conditions, a fraction of the total amount of ink intended to be used to fill the cartridge,
f. releasing the vacuum, and
g. dispensing in a second fill step the remaining amount of ink intended to be used to fill the cartridge under substantially atmospheric conditions.

2. The process of claim 1 where during the first filling step conducted under vacuum conditions is the ink dispensed at a flow rate no greater than 0.5 ml per second.

3. The process of claim 1 where the vacuum reached inside the vacuum chamber is at or more than 300 mm of Hg.

4. The process of claim 1 where the vacuum is released over a period of 9 to 40 seconds.

5. The process of claim 1 where the amount of ink dispensed during the first filling step conducted under vacuum conditions is between 30% and 70% of the total amount intended to be used to refill the cartridge.

6. The process of claim 1 wherein the ink reservoirs of the ink jet cartridge contain foam or other porous material.

7. The process of claim 1 wherein the process is incorporated in a refill kiosk located in a retail environment.

8. An ink jet cartridge refill station for use in a retail environment, said refill station equipped with a fill fixture and other means that can refill the cartridge according to the method of claim 1.

9. A process to refill ink jet cartridges, said process comprising:
a. inserting needles into the ink reservoir of the cartridge through existent vent holes and/or other previously made access orifices, and
b. dispensing the total amount of ink intended to be used to fill the cartridge at a flow rate no greater than 0.5 ml per second.

10. The process of claim 9 wherein the ink flow rate is no greater than 0.2 ml per second.
